(19) United States
(12) Patent Application Publication
(10) Pub. No.: US 2010/0320349 A1
(43) Pub. Date: Dec. 23, 2010

(54) DISPLAY DEVICE STAND

(76) Inventor: DEL H. NECESSARY, PLAYA DEL REY, CA (US)

Correspondence Address: KLEINBERG & LERNER, LLP, 1875 CENTURY PARK EAST, SUITE 1150, LOS ANGELES, CA, 90067, US

(21) Appl. No.: 12/791,647

(22) Filed: Jun. 1, 2010

Related U.S. Application Data
(60) Provisional application No. 61/187,773, filed on Jun. 17, 2009.

(51) Int. Cl. F16M 13/00

(52) U.S. Cl. 248/346.03

(57) ABSTRACT

A case for a portable display device is subdivided into two portions which can be slidably mounted on the display device as a protective case. One of the portions is provided with slots which are the width of the display device case thickness so that the device can be inserted into the slots and present a more or less upright orientation of the device so that the display can be viewed.

### CROSS REFERENCE TO RELATED APPLICATIONS

Provisional Application for patent Ser. No. 61/187,773, filed Jun. 17, 2009.

### STATEMENT REGARDING FEDERALLY SPONSORED RESEARCH/DEVELOPMENT

None.

### REFERENCE TO MICROFICHE APPENDIX

None.

### BACKGROUND OF THE INVENTION

1. Field of the Invention

The present invention relates to display devices and, more particularly, to a stand for hand held personal data assistants (PDA, cellular telephones, digital cameras, handheld video players and other small devices with a display capability, all of which, for convenience, will be referred to as PDA's.

2. Description of the Related Art

Today, many handheld devices include a display screen which can show images, icons, or other information to the user. When not being hand held, such devices can be placed in a separate device which supports the display device at an angle and frequently includes a stand which may fold out and upon which the device may rest. Alternatively, an easel type stand may be supplied. Such supporting devices are frequently separate and distinct from the display device and constitute an additional hardware component that must be carried about. Other devices include hinged covers which can be used to support the device so that the display can be viewed.

Alternative support devices may include clips or swing arms that are adapted to receive the display device. Each requires a component that is separate from and independent of the display device itself. What is needed is a device that can act as a hands free support for the display device and yet have an additional, protective function.

### SUMMARY OF THE INVENTION

In accordance with the present invention, a relatively rigid case member can enclose the PDA, protecting the relatively fragile display screen. The case member has a precision slot that is wide enough to hold the PDA at an angle to the vertical whether in a portrait or a landscape orientation. If the case completely encloses the PDA, the slot spans the surface of the case and extends through the side walls. If the case only enclosed the back and sides of the PDA, the slot need only be in the side walls. With such a slot, the angle of the display can be determined and the PDA can be supported with a horizontal orientation. If the case includes a top flange, partially covering the upper surface of the PDA, then the slot would also cut through the top flange and the PDA can be supported in either a vertical or horizontal orientation.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is perspective view of a case according to an embodiment of the present invention;

FIG. 2 is a perspective view of the case of FIG. 1, but opened;

FIG. 3 is a side view of an alternative case portion with a device inserted vertically into slot; and

FIG. 4 is a side view of the case portion of FIG. 1 with a device inserted horizontally into a slot.

FIG. 5 is a side view of a preferred embodiment of the invention with two pairs of slots, each pair aligned for a different viewing angle.

### DETAILED DESCRIPTION OF THE INVENTION

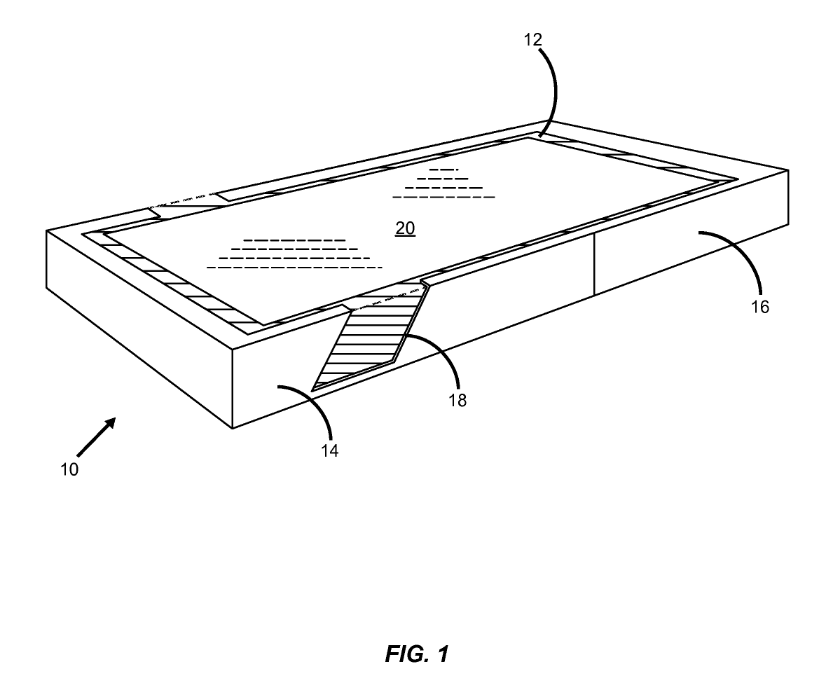

Turning first to FIG. 1, there is shown, in perspective, a protective case 10 according to an embodiment of the present invention. Within the case 10 is a PDA 12, which may be a personal digital assistant, a “tablet”, an e-reader, a cellular phone, a digital camera, or an MP3 player of a type sold by Apple Computer Co. as an iPod® in its many variations. The case 10 is in two parts including a “removable end” 14 and a “fixed end” 16. One end of the PDA 12 is inserted into the fixed end 16 and the removable end 14 is fitted over the PDA 12 so that the PDA 12 is enclosed within a protective case.

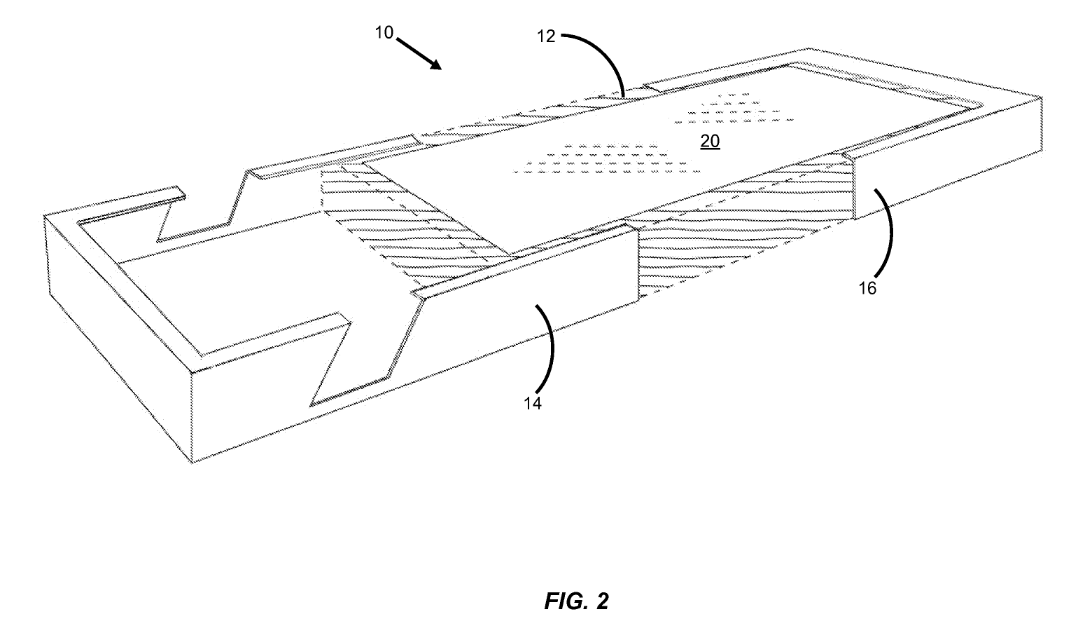

Within the removable end 14 there is at least one angled slot 18 in each side of the end. The slot 18 is angled so that when it receives the PDA 12, the PDA 12 will be at an optimum angle for viewing its screen 20. In FIG. 2, the removable end 14 is shown as partially removed from the PDA 12 which it is housing.

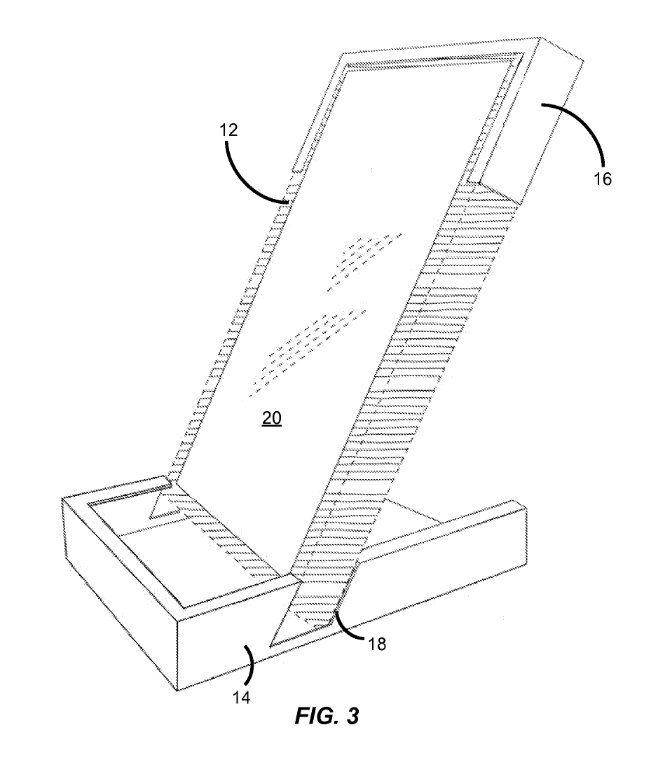

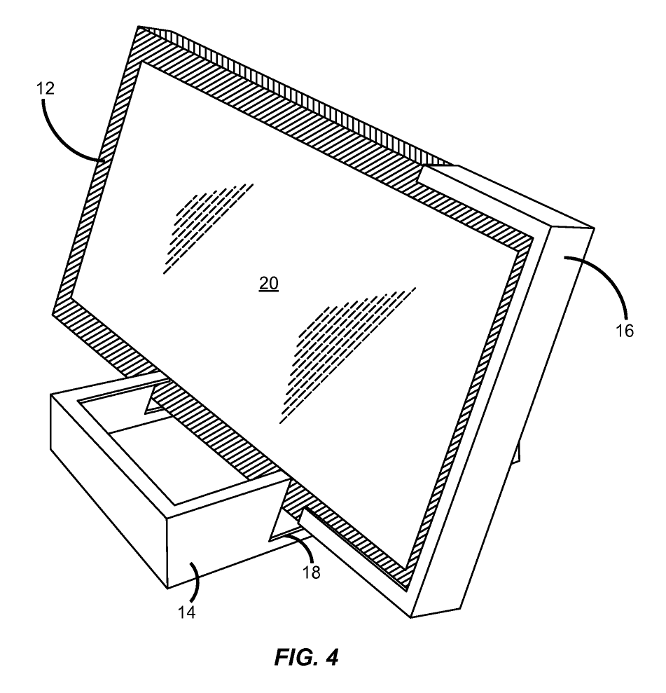

In FIG. 3, the PDA 12 is shown supported in the slot 18 at a convenient angle for viewing the screen 20. While the PDA 12 is shown here in a vertical orientation, a horizontal orientation is shown in FIG. 4. The case 10 is of sufficiently rigid material that it will easily support the PDA 12 in the slot 18.

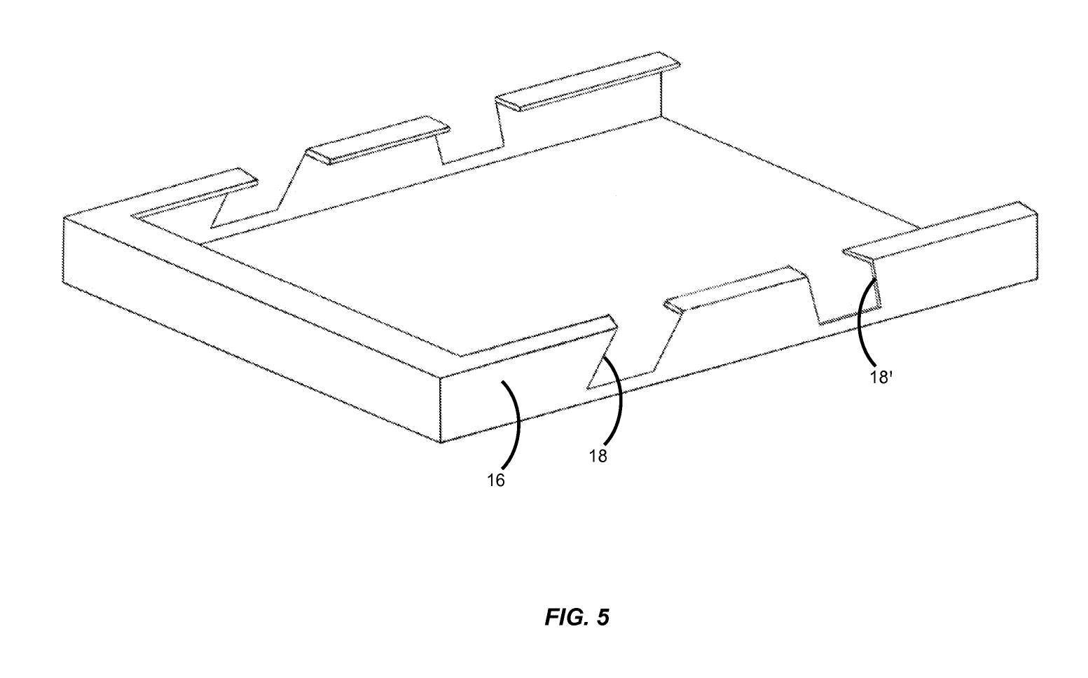

Turning finally to FIG. 5, there is shown a preferred embodiment in which the removable end 14 has two slots 18, 18′. One of the slots 18 is oriented at a 30° angle while the other slot 18′ is oriented at a shallower, 15° angle. This embodiment provides for greater choice in the viewing orientation of the PDA 12 whether in the “portrait” (or primarily vertical) mode or “landscape” (or primarily horizontal) mode.

Thus there has been shown and described a protective case for a PDA device which can also function as a viewing stand with a choice of viewing angles and a choice of device orientations.

Other embodiments and alternative variations can be devised by those skilled in the art and the scope of invention should be limited only by the breadth of the claims appended hereto.

1. A case for holding a portable display device comprising:
a. a first case portion having a base, sides and a first end, said sides and end having a top flange for partially enclosing a portable display device;
b. a second case portion having a base, sides and a second end, said sides and end having a top flange substantially similar to said first case portion top flange;
c. a slot pair with slots in opposite sides of one of said case portions, said slots extending through said top flanges and to said base, having a width substantially equal to the height of said sides,
whereby the portable display device can be alternatively enclosed by said first and second case portions and is insertable into said slots to be supported therein in an elevated orientation for display viewing.

2. The case of claim 1 wherein the portable display device is supported in a portrait orientation.

3. The case of claim 1 wherein the portable display device is supported in a landscape orientation.

4. The case of claim 1 wherein said one of said case portions has a second slot pair with slots in opposite sides, said second slots extending through said top flange and extending to said base at an angle different from the angle of said first slot pair whereby the portable display device can be alternatively supported by said first slot pair at a first angle and by said second slot pair at a different angle.

5. A case for enclosing a portable display device comprising:
a. a first case portion having a back, sides, a closed end and an open end, said sides and said closed end having a top flange;
b. a second case portion having a back, sides. a closed end and an open end, said sides and said closed end having a top flange; and
c. a pair of first slots in opposite sides of one of said case portions, each said first slot having a width approximately equal to the thickness of the portable display device, each said first slot extending through said top flange and said sides to said case portion back;
whereby the portable display device can be enclosed by said first and second case portions and whereby the display device can be supported in said pair of first slots in an elevated position where said display can be viewed.

6. The case of claim 5 wherein the portable display device is supported in a portrait orientation.

7. The case of claim 5 wherein the portable display device is supported in a landscape orientation.

8. The case of claim 5 wherein said one of said case portions has a second slot pair with slots in opposite sides, said second slots extending through said top flange and extending to said base at an angle different from the angle of said first slot pair whereby the portable display device can be alternatively supported by said first slot pair at a first angle and by said second slot pair at a different angle.

9. A case for enclosing a portable display device comprising:
a. a first case portion having a back, sides, a closed end and an open end, said sides and said closed end having a top flange;
b. a second case portion having a back, sides. a closed end and an open end, said sides and said closed end having a top flange; and
c. a pair of first slots in opposite sides of one of said case portions, each said first slot having a width approximately equal to the thickness of the portable display device, each said first slot extending through said top flange and said sides to said case portion back;
whereby the portable display device can be alternatively enclosed by said case portions and be insertable into said first slots to be supported by said first slots and said top flange in an elevated orientation for viewing of the display.

10. The case of claim 9 wherein the portable display device is supported in a portrait orientation.

11. The case of claim 9 wherein the portable display device is supported in a landscape orientation.

12. The case of claim 9 wherein said one of said case portions has a second slot pair with slots in opposite sides, said second slots extending through said top flange and extending to said base at an angle different from the angle of said first slot pair whereby the portable display device can be alternatively supported by said first slot pair at a first angle and by said second slot pair at a different angle.
